(19) United States
(12) Patent Application Publication
(10) Pub. No.: US 2020/0367457 A1
(43) Pub. Date: Nov. 26, 2020

(54) MODULAR AGRICULTURE SYSTEM

(71) Applicant: ELEMENTS WORKS SRL, Pisa (IT)

(72) Inventor: Michele Grassi, Pisa (IT)

(21) Appl. No.: 16/491,992

(22) PCT Filed: Mar. 9, 2018
(86) PCT No.: PCT/EP2018/055959

§ 371 Date: Sep. 6, 2019

(30) Foreign Application Priority Data
Mar. 9, 2017 (GB) 1703751.6

(51) Int. Cl. A01G 33/00; A01K 61/80

(52) U.S. Cl. CPC A01G 33/00; A01K 61/80

(57) ABSTRACT

A modular agriculture system for use underwater. The system comprises a plurality of node elements (101) each including an agricultural unit and a plurality of connection elements (201) for inter-connecting at least some of said nodes to form a mesh-like structure with nodes at the mesh junctions. A significant portion of said connection elements (201) are of low cross section such that when in use and placed underwater they present a low resistance to the action of waves and currents. A plurality of tensioning elements are connected to the mesh-like structure to place the connection elements (201) in tension.

### FIELD OF THE INVENTION

The present disclosure relates to a modular agriculture system for underwater use. Embodiments of the invention are especially advantageous when used on sand or other loose substrate, possibly also sloping. Some embodiments are useful to support underwater plants, for reforestation purposes useful to fight erosion or to mitigate plant depletion or for large scale underwater cultivation, especially in hydrodynamic locations where a stabilization of the plants is needed, or during the first phases of rooting of the plants, during which their link to the substrate is less firm. Some other embodiments are useful in aquaculture, to support, protect or to distribute in an efficient and environmentally mindful way, nutrients and other useful elements to fish or to the other marine life to be cultivated.

### BACKGROUND OF THE INVENTION

Underwater cultivation encounters several problems which are not typical of traditional, in-air cultivation. One first obvious problem is that the operator needs to move in the underwater environment, possibly even completely submerged and often with limited visibility. A second problem is that the soil is usually not as coherent as that on land, due to the presence of water, and therefore plants or seaweeds can be more easily displaced from their expected position. A third problem is that movements of water (due to waves or to currents) have a much greater impact on specimens than that due to the movement of air on traditional cultivation. A fourth problem is that the traditional approach of using greenhouses to increase yield or for other purposes cannot be applied underwater, barring some very special situations, due to the huge impact of waves and currents on any underwater structure. In the case of fish farming, usually fish are not fed by growing plants or algae and then letting them feed on what grows, mainly because of the above listed limitations in high efficiency farming. If it were possible to grow plants of seaweed in an efficient and predictable way, it would be possible to let fish graze on them, with a huge improvement in terms of efficiency and of availability for fish farming. Embodiments of the invention could also be used to supply feedstock or other foods to fish or animal feeders underwater.

Regarding the problem of operators having to enter in the underwater environment, this is problematic in all phases of cultivation but particularly during plantation and during harvesting (in case plants or algae need to be harvested). The traditional methods of underwater plantation used, for example, in underwater reforestation projects, require the operators (scuba divers) to move both horizontally and vertically in the water column, to collect the specimens to be implanted and then to position them on the sea floor. This activity is expensive, dangerous and very slow, and requires specialized operators who have experience in handling underwater plants (scientific scuba operators) which are difficult to come by and expensive. Indeed, the need for highly specialized operators makes these activities cost effective only for very high value projects. An approach to this problem is that of WO2012174983A1, where the cultivation is done on a suspended, floating structure. This approach however is limited to confined waters where waves cannot reach, as even a small storm would completely dismantle any such apparatus. Furthermore, this solution applies to plants which do not need soil in direct contact, and is therefore more akin to so-called hydroponic cultivation rather than bona fide agriculture.

The fact that the soil is often not very coherent means that the plants or seaweed will not stick in place before they rooted, resulting in possible loss of the whole cultivation if there is in addition a particularly hydrodynamic climate or an occasional storm. To resolve this problem, during plantation the small plants are usually inserted deep into the soil or plant support substrates are put in place. These plant support systems are needed in various situations, for example for allowing newly planted specimens to develop enough so that they will be able to withstand waves and currents on their own. This applies for example in mitigation projects, where an underwater activity causes environmental damages and to contrast these damages a reforestation of plants or seaweed is put in place in the same area, or in nearby ones. Other situations in which such systems might be needed is when it is required or advisable to monitor the cultivation, or to feed the growing plants during some phases of development, or to illuminate them to help or accelerate growth, or to protect them from predators when they are particularly vulnerable.

A single storm, given the high impact of water on the newly planted specimens (or even on rooted ones) can wipe out an entire cultivation. This is similar to what happens on land, where however the problem can be mitigated by covering the newly planted specimens (or the older but still delicate ones) with covering structures, nets or greenhouses. This approach unfortunately cannot be applied underwater. Water density being almost 1000 times bigger than that of air, systems used in air to protect, nurture and accelerate growth like greenhouses or plant covers pose engineering problems very difficult to solve in an economical and scalable way. For instance, an underwater greenhouse would be subject to huge forces by waves and currents and its construction in a way which can resist such forces would have costs well beyond the value of the cultivation to be protected. All these problems are solved by the present invention.

For the problem of stabilization of underwater plants until they are rooted, there are several partial solutions know in the prior art, none of which is completely satisfactory. These solutions range from single plant enclosures to larger structures hosting several plants, with or without a frame. In all known cases the stabilization and protection of plants is obtained with bulky devices which are impacted significantly by waves and currents, thus being prone to failure on one side and requiring extensive stabilization efforts on the other.

One approach present in the prior art is to use large bags full of stones or sand or other heavy loose material (for weight) and to insert the plants in the exterior of the bag itself or in an additional layer of fabric (or plastic) where the plants can rest and root. These bags are stabilized by their own weight, but are very much subject to the erosion of the substrate around them by waves and currents, and they can be easily lifted and moved around and capsized by storms, causing the total loss of the plants attached to them. They additionally constitute a significant addition of alien material (some of which very often is not biodegradable) and therefore negate the very aim of the conservation projects in which they are used.

Another method is to use mats made of fibers or plastic material like in CN202107575 (U), including possibly growth substrate on which the plants will root. The problem with these solutions is that they can be easily impacted by waves and currents, especially if the water finds a way to the part below them. When this happens, the structure will be moved around by the waves or the currents, resulting in total loss of the cultivation.

Another method present in the prior art is to use frames made of cement, inside which there is fixed a fabric (textile or, more often, synthetic) with or without a support steel net, where the plants are infixed. Experience shows that the stability of these solutions during storms is very limited, and therefore to keep them in place they are often connected to structures inserted deep into the substrate (often by several meters) to which they are connected through ropes or cables. The environmental impact of these solutions is very significant, and their effectiveness very limited given that often sand and terrain is brought inside the frame by waves and currents and it suffocates the plants before they reach a size large enough not to be covered.

Still another method is to use a rigid frame, in the shape of an octopus or other, which is stabilized on the ground by soil penetrating devices or gravity based ones, and over which the plants are positioned, or an artificial reef like in KR101623067 (B 1). These structures are very prone to being displaced by waves and currents, and are moreover often made of non-biodegradable materials so that the environmental impact of such a solution can be very high. Furthermore, these units need to be laid down one by one by scuba operators, with a very significant overhead cost and added operational risk.

Another approach is that of CN105130000 (A), where there is a “terraforming” effort to modify the underwater environment and align it as much as possible to the one present in air. This approach, of course, encounters several limitations from the point of view of cost and of ecological compatibility, and is also very demanding from the point of view of maintenance.

All the above methods tend to replace the preexistent soil with a new one, where the plants will grow. In this they all resemble more a hydroponic cultivation than standard agriculture, and by doing so they do not use the natural soil present, at least during some phases of the plants growth. This makes these methods very expensive and not scalable.

Greenhouses are used in air not only to protect the plants, but also to apply methods to increase yield or accelerate growth, or to provide nutrients which would be dispersed by rain or other atmospheric agents. This type of action is very difficult to apply in the underwater environment due to the previously indicated limitations of current approaches.

Thus, there remains a need for an underwater agriculture system.

### SUMMARY OF INVENTION

The present invention provides a system as defined in independent claim 1 to which reference should now be made. Preferred and/or alternative features of embodiments of the invention are set out in the dependent claims.

Embodiments of the invention are concerned with providing a cultivation system for use in an underwater space which is modular, extensible and easy to install, while remaining of very low cross section against the water. Some embodiments of the system furthermore allow for the implementation of several of the actions traditionally performed in standard (in air) greenhouses.

A preferred embodiment consists in having a plurality of nodes, possibly one for each plant to be cultivated or for each dispenser to be operated, a network of streamlined connecting elements between the nodes which is kept in tension by a set of tensioning and stabilization elements to stabilize the whole system with respect to the sea floor. The mesh of nodes and connecting elements is laid on the sea floor and made to adhere to it by the tension induced inside it by the tensioning elements and by the stabilization that they provide. The connecting elements are very low profile, typically only a thin rope or cable or tube (or a combination of these), thus receiving little force from water movement. A significant portion of said connection elements are being of low cross section such that when in use and placed underwater they present a low resistance to the action of the waves and current actions and distributed across said mesh so that their presence significantly reduces the movement of said nodes inside the local plane identified by said mesh.

The nodes may be miniaturized greenhouses, made possible by modern manufacturing techniques and technology (when they are technology rich). In some instances they can be only a platform, stabilized by the connecting elements to the other nodes, where an underwater plant or seaweed can safely grow until its roots are firmly into the ground. The tensioning and stabilization elements comprise a combination of fixtures or weights connecting to the sea floor, elastic elements (like coils, pistons, elastic ropes) to preserve tension, tensioning points possibly distributed on tensioning lines (possibly elastic, but not necessarily) to which the connection elements of the nodes can be attached.

This “miniaturization of the greenhouse” approach with a minimization of the connection elements and the use of tension to keep the nodes in place reduces the number of fixtures or connections to the sea floor, while guaranteeing the stabilization of the nodes with very low water impact, cost and weight. This approach allows for a more industrial approach to underwater cultivation, where the plants can possibly be positioned on or inside their support nodes beforehand (even outside of the water) and then the whole system can be positioned on the sea floor with minimal or no need for underwater activity by the operators. Additionally, this approach allows for a simple distribution of energy, nutrients and data along the network of connecting elements from a single hub (or a plurality of hubs positioned inside the cultivation field) thus making possible a whole range of high technology solutions through the application of miniaturization, telecommunications, electromechanical solutions (possibly controlled by one or more PLCs, computers or other digital devices), led lighting or other solutions typically used in conjunction with greenhouses in traditional in-air cultivation. It is also possible, where ecologically compatible, to use a distribution network along the connecting elements, possibly in the form of pipes, or active systems and storage in the nodes to combat parasites or to distribute other substances to sustain the growth of the cultivation.

When aquaculture of fish or seaweed is involved, the support nodes can be used to distribute food to fish or plants, thus reducing substantially the amount of food which is dispersed outside of the cultivation area and the environmental impact of the installation. The seaweed or plants can be part of the food for fish, and nutrients can be fed to the nodes through a network of small pipes along the connecting elements. The nodes can be equipped with algae-like structures or other systems (like small vertically distributed pipes) which can help in bringing the nutrients out, in supporting and guiding the rapid growth of the vegetable mass and in making it accessible to a large number of fish, while preventing it from being dispersed by waves or currents. This method for aquaculture is close in its approach to so-called drip irrigation for in-air agriculture, and allows for a much smaller amount of nutrients to be dispersed in the water.

The structure of a basic embodiment of the invention is composed of three main components: a plurality of nodes, a plurality of connection elements connecting the nodes in a mesh or network and finally a plurality of tensioning and stabilization elements attached to either the nodes or the connection elements or both and positioned within the mesh or around it or both. In case of cultivation, the tensioned network of nodes will keep the position of the plants or seaweeds (which are housed on the nodes) stable enough for them to root (if that was the aim of the system), while providing (at least in some embodiments of the invention) nutrients, light or other support and (at least in some other embodiments of the invention or in combination with the previous ones) allowing for the use of monitoring systems or protection systems. The basic idea is to miniaturize an underwater greenhouse and to distribute it on the sea floor and close to the plants or seaweeds to be grown, in the form of nodes which are positioned exactly where they are needed. The nodes can provide not only distribution of nutrients, light or heat but also support for the plants themselves or feeding space for large schools of fish in an ecologically mindful way. They can also contain monitoring equipment like sensors for salinity, turbidity, acidity, sound or similar. Where the site ecology or regulation warrant this, the whole system can be made to be biodegradable, with the possible exception of the sensors or actuators where present, which can however be designed to be easily recoverable.

In a preferred embodiment of the solution, the tensioning elements are laid circumferentially around the area directly interested by the nodes. The actual tension may be obtained through devices activated remotely or on site by divers, so that the mesh formed by nodes and connecting elements will be kept with the desired tension and possibly this tension may be restored periodically acting again on these tensioning elements if it decreases with time, due to for example, creep on textile lines where present. If the sea surface is flat or convex this arrangement will be enough to keep the system adherent to it, while if it is concave some or all the nodes will have a way to remain close to the sea floor (for example, their weight or a small surface penetrating component) and in addition there may be one or more tensioning and stabilization elements within the mesh acting as a point of bottom fixture.

The system may be deployed having the mesh rolled around a support tube (or other structure) which is then retrieved after having positioned the system in place or left on the site if it is made of easily biodegradable material which does not negatively affect the target environment. In a variation, the mesh may be lowered in the water from a boat when it has been already extended, and then lowered on the sea floor in this condition. In still another variation, the system is laid on the water surface by the use of small floaters or a circumferential floating frame, it is lowered to the sea floor still attached to this frame (which has been possibly deflated or has been detached from floaters which kept it on the surface) and then the frame is removed after the mesh has been connected to the tensioning elements. In still another variation, the components of the system (nodes, connecting elements and tensioning elements) are assembled together directly underwater by divers or by ROVs. This is in any case much simpler and less expensive than other solutions present in the prior art given the very low cross section and weight of all components involved, which allow divers to work on them without the need to use additional large equipment.

In a variation of this solution, the nodes contain feeding, heating, cooling, illuminating or other elements acting on the plants or on fish; they can also contain monitoring solutions (monitoring temperature, salinity, acidity, nutrients, actual growth etc.) or can be hybrid, both acting on and monitoring the plants, seaweeds, fish or other marine life to be cultivated or supported. These additional devices may be self-powered, or may extract energy from the surrounding environment (for example through individual solar panels), or in still another variation they may obtain power through power lines laid along (or coinciding with) some of the connecting elements between the nodes. For example, the nodes may contain lighting, possibly generated by LEDs, to accelerate the growth of the plants and guarantee that roots develop quickly, in particular to reach as quickly as possible the point where the plant will not risk being displaced by waves or tides.

In another variation of the system, there is inside it or close by a wave or tidal energy converter which extracts mechanical energy from the surrounding environment and uses the energy thus collected directly for the plants or to power up additional instruments contained in the nodes or intermediate hubs distributed within or around the mesh.

In another variation of the system, the connection of the nodes to the connection elements and to the tensioning and stabilization ones is designed so that it can be carried out by a mechanical system directly underwater, possibly prior to deployment on the sea floor. This arrangement allows for large scale deployment of plants by mechanical means, possibly even without human intervention on site, and therefore opens up the possibility of extensive cultivation in the underwater environment at a cost which is sustainable.

### PREFERRED OR ALTERNATIVE EMBODIMENTS

Various objects, features, aspects, and advantages of the present invention will become more apparent from the following detailed description of preferred embodiments of the invention, along with the accompanying drawings in which like numerals represent like components. Embodiments of the invention will be described by way of non-limiting examples with reference to the attached figures in which:

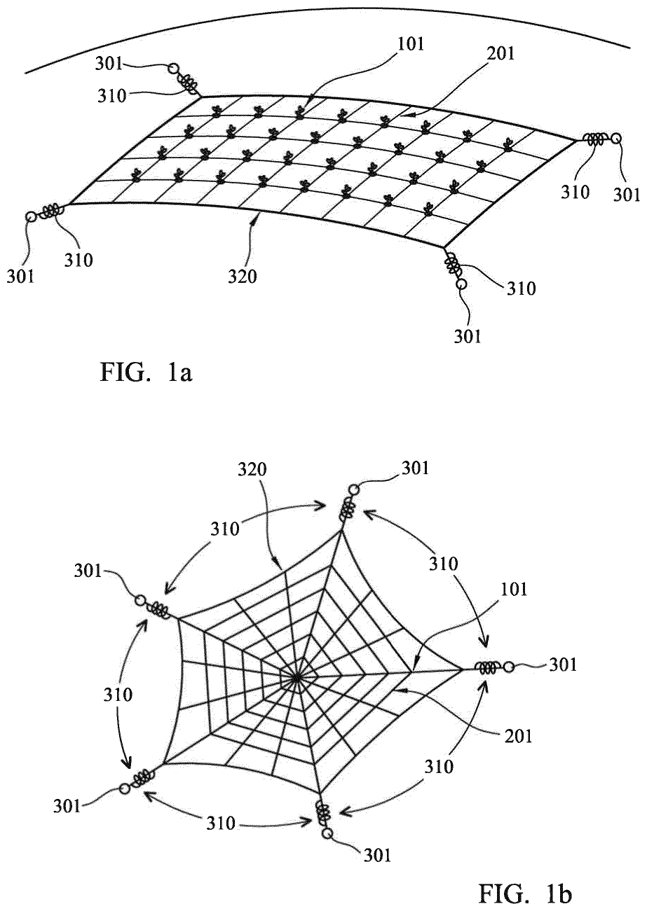

FIG. 1a is a schematic view of a sea (lake, pond) bottom portion with Embodiment 1 in place over it;

FIG. 1b is a schematic view of a variation of Embodiment 1, where the geometry of the mesh is not rectangular

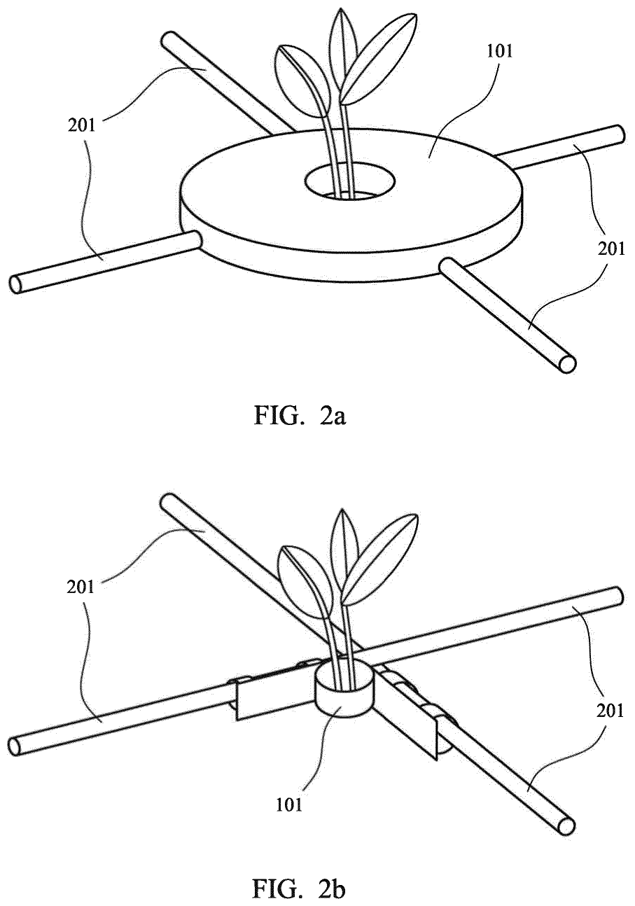

FIG. 2a is a schematic view of a node of Embodiment 1, with part of the connection elements converging on it.

FIGS. 2b, 2c, 2d are schematic views of variations of one of the nodes of Embodiment 1, with part of the connection elements converging on them.

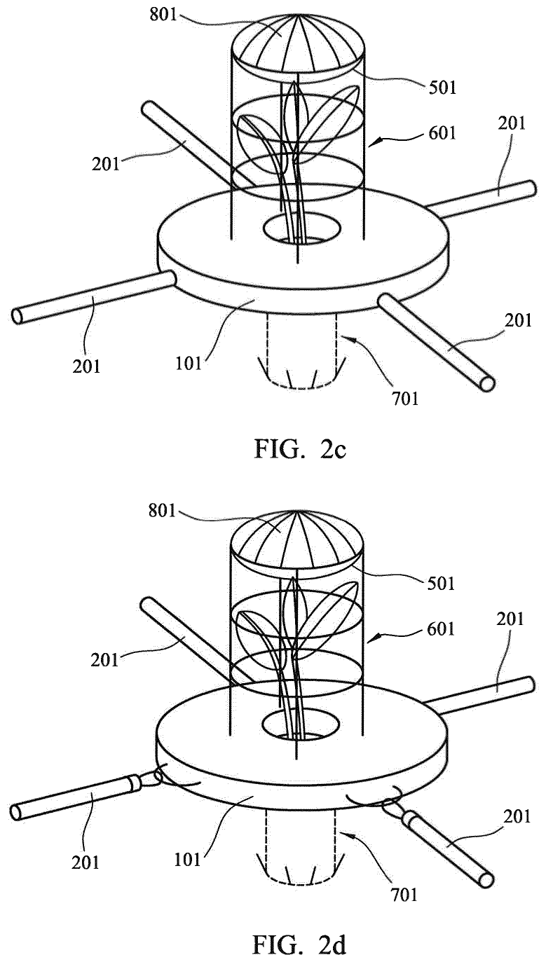

FIG. 3a shows a way to fold the mesh of Embodiment 1 and of Embodiment 2 on a tube, in preparation for deployment

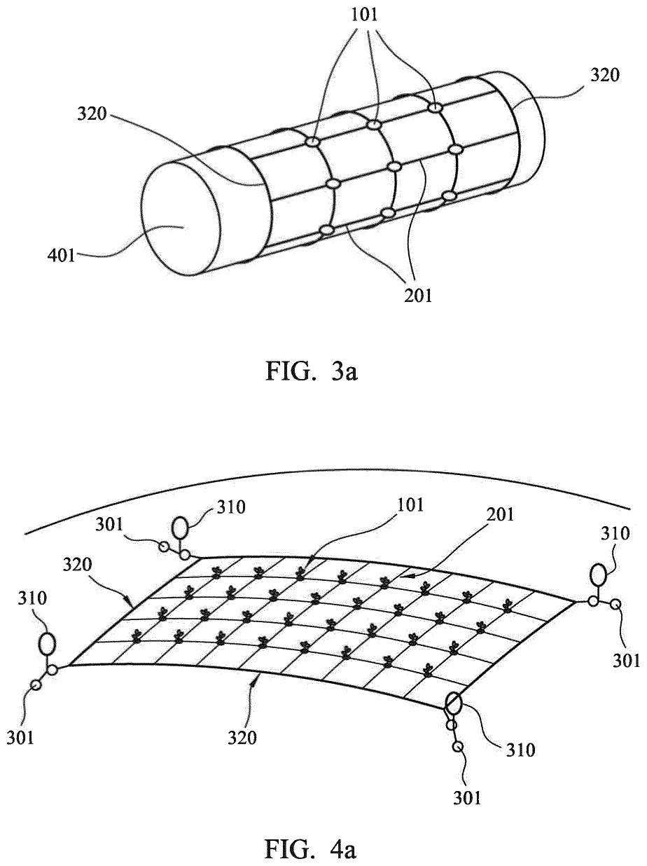

FIG. 4a is a schematic view of a portion of sea (lake, pond) bottom with Embodiment 2 in place over it.

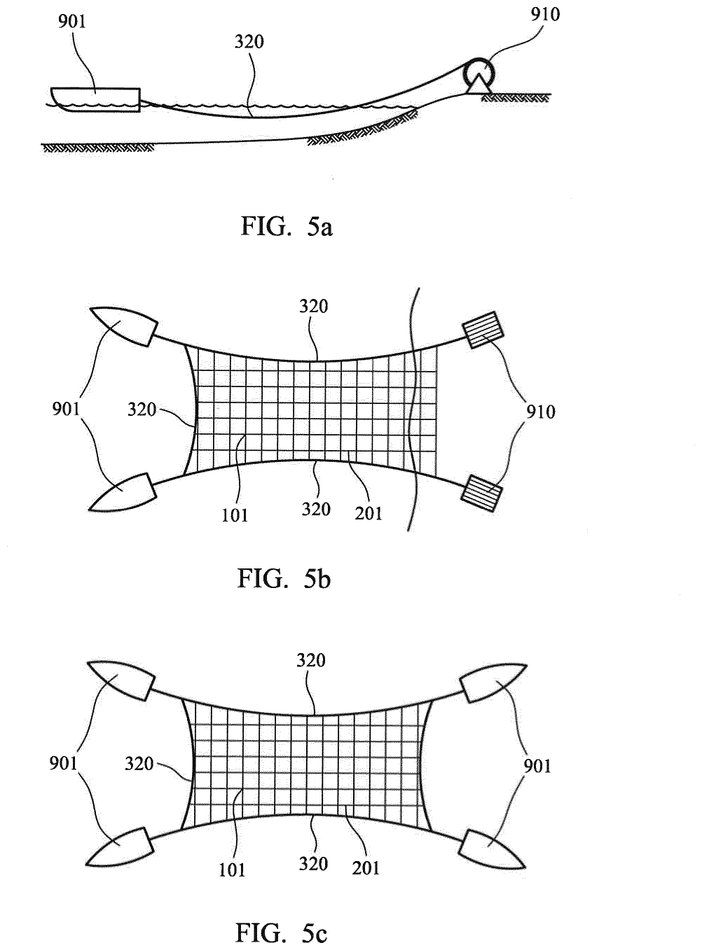

FIG. 5a-b-c contain a schematic view (side and from top) of some possible deployment procedures.

We describe in the following some embodiments of the present invention, which exemplify the main features in away which makes it possible for someone skilled in the sector to build it. The embodiments are necessarily specific on several points and make quantitative choices on dimensions and components of the system, without implying that these choices are essential to explicate the innovations ofthe invention. They are merely a necessity to describe a real instance of the device.

FIG. 1a is a general overview of Embodiment 1 comprising a plurality of nodes hosting plants or seaweed (101), their connecting elements (201) and external tensioning elements in the form of a circumferential line (320) tensioned by four elastic lines (310) connecting it to stable fixtures on the sea bottom (301). The external line 320 can have a curvilinear shape (as seen from above) to better transmit tension to the connection elements 201. In FIG. 1b we describe one of the possible alternative geometries for the cultivation system, where the nodes 201 (not drawn in the picture) are placed at the intersection of three lines. The actual dimensions of a complete system can vary from very small (node distance 15 cm or less, tensioning lines length 2 m or less) to very large (node distance 0.5 m or more, tensioning lines length 1 Km or more). The connecting and tensioning lines may be lines or cables of a material of sufficient strength (e.g. ropes or steel cables). Such lines have a low cross-section and therefore present a low barrier to water impacting or incident on them.

The nodes of this embodiment are made of biodegradable material and steel (FIG. 2a). Each one of them is a wooden disk (101) with a central hole where the plant is inserted, and crossed in perpendicular directions by the connection elements (201) which are biodegradable ropes. In a standard configuration, the diameter of the disk might be 5 cm, with the central hole 2 cm of diameter. The ropes cross continuously through the node 101, to better preserve tension, and the node 101 is stabilized entirely by the presence of tension in the elements 201.

In a variation of this embodiment described in FIG. 2b, each node 101 is composed of an L-shaped steel plate, to which is welded a small tube (on the inside of the L and with its vertical axis orthogonal to both the convergent ropes at that given node) and to the outside of each one of the two legs of the L are connected two semicircular structures, which contain the connection elements 201 (which are two ropes in this case) in a pass-through configuration. It is also possible to use a configuration where the two semicircular structures have an opening (one on the top part and the other one on the bottom one) so that the rope can be inserted inside and then will remain in place due to its tension. To remove the rope from the housing it is necessary to bend the whole system in a way which should be almost impossible to be caused by the wave or current action. The same movement is however easy to be put in place by an operator who wants to connect the device to the node between two intersections ropes or who wants to remove the device from its position. The plant is inserted inside the tube, either before final deployment of the system on the sea floor or after that. A node 101 like this has the advantage of being very low profile against the water while providing improved stabilization against rotation induced by waves or currents.

The connection elements are made of biodegradable ropes based on vegetable fibers. This allows the connection elements to self-dissolve over time, once the plants have rooted and there is no more need for their stabilization. If the nodes are also made of biodegradable material like wood or non-stainless steel, they too will dissolve over time leaving the plants or seaweed completely free.

The tensioning and stabilization elements 320 are located circumferentially outside of the area interested by the nodes, and are put in tension by a flexible element 310 (like a coil or a piece of flexible rope) connecting them to a soil penetrating anchoring system attached to biodegradable ropes 301 (FIGS. 1a and 1b).

To install the system, the network formed by intersecting ropes is laid on the ground on land, and the nodes are connected at each intersection of two transversal ropes. The system so composed is then rolled around a lightweight tube (401) to make it easily transportable (FIG. 3a). The nodes and the mesh are disposed on the tube in a way which allows several layers of mesh to superimpose on itself.

Divers or remotely operated vehicles (ROVs) bring the tube 401 with the rolled mesh of ropes and nodes on the site destined for the installation, and then unfold it by unrolling the tube. After this or prior to this the tensioning and stabilization elements are put in place, the mesh is connected to them via external tensioning devices (like a tackle) and then a biodegradable rope is fastened in position to keep the system tensioned, and the external tensioning devices are removed and taken away.

In a variation of this embodiment, each node includes a detachable apparatus (501) capable of generating light when ambient light decreases below a certain level (FIG. 2c-2d). Each one of these detachable devices is connected via an electrical cable which runs along connection elements to a central hub which powers all of them. This central hub may contain energy storage components and systems to generate electricity locally from waves or from a tidal stream where present.

The added light accelerates growth of the plants and reduces the risk of them being washed away by particularly energetic storms or by erosion of the substrate on which they are rooting.

In another variation of this embodiment, electricity is collected by a small solar panel (801) attached to the node itself with no need for a central hub or electrical connectivity along some of the connection elements. (FIG. 2c-2d).

Other variations include soil stabilization fixtures directly connected to the nodes (701, FIG. 2c-2d) or plant protection structures (601, FIG. 2c-2d).

It is also possible to have some or all of the connection elements 201 not pass-through but terminated on the node 101 (FIG. 2d).

In a second embodiment of the present invention (FIG. 4a), the mesh of nodes 101 and connection elements 201 are as in the preceding FIG. 1a (or any of its variants) but the tension in the tensioning and stabilization elements on the tensioning lines 320 is induced by floaters 310, which put in tension lines going through pulleys attached to fixtures 301 on the sea floor.

This solution has the advantage of a simpler installation, as the length of the ropes connecting the tensioning lines to the sea bottom fixtures is self-regulated by the movement on the pulley, whereas in the case of the use of springs or elastomers the system needs to be put in tension by the operators.

A disadvantage with respect to the solution with springs or elastomers is that the floaters 310 will be affected by waves or currents. This impact is however going to be very small compared to what would be the impact of an extended support structure like those used in the prior art, as the tension which needs to be applied is comparatively small. It is also possible to use “tackle” arrangements to multiply the force exerted by the floaters, thus allowing for their displacement to be reduced. The expression “tackle” arrangements is used to describe pulleys, combinations of pulleys and the like which can be used to multiply or reduce forces applied and/or needed to be provided.

A third embodiment of the present invention has the same types of mesh of nodes and connection elements as the previous ones, but at least some of the stabilization and tensioning elements utilize the force generated by weights suspended from the ends of cables which run over a first pulley or similar arrangement from the mesh-like structure on the sea floor up to a second pulley or similar located above the mesh-like structure to generate the tension to be transmitted to the mesh itself.

In a basic instance of this embodiment, there are pipes connected stably to the sea floor with pulleys suspended by said pipes above the sea (lake, pond) bottom and pulleys at their base. The pulleys are used to deviate a rope connected to the tensioning lines positioned circumferentially around the mesh, and a weight is suspended to the opposite end of said rope. Gravity pulls down the weight, putting the rope in tension and this tension is transmitted to the tensioning lines.

In a variation of this embodiment, a tackle arrangement increases the force exerted by the weight. In still another variation, the tackle arrangement decreases the run of the weight.

All three of the above embodiments can be deployed in an efficient way, either from a floating vessel or from shore. In an exemplary method for deployments from shore described in FIG. 5a and FIG. 5b), two lateral tensioning lines 320 are laid between shore and two vessels (or Remotely Operated Vehicles) 901, which keep them in tension in the direction for deployment. On land, the two lines pass through two traction winches 910 which unroll them while the mesh gets assembled and connected in the space between them and close to the ideal line joining the two traction winches. As the mesh is assembled and connected to the tensioning lines, the winches release part of the lines themselves and the vessels move outwards.

This method results in a tensioned mesh which is deployed at sea (lake, pond) incrementally until it is all over the water. At this point it can be lowered directly on the sea floor or two additional vessels can take the terminations of the tensioning lines and move at sea together with the other two, to place the tensioned mesh at the desired location (FIG. 5c). Using this approach or any of a number of possible variations of it, it is possible to deploy an entire cultivation system at sea in just a few hours, even if the system has very large extension.

If the system is deployed in “bands” not too large, a mechanized system can also recover it at time of harvest (or of demobilization for any other reason) by pulling it from the sea floor. In this case roots of the plants might be a limiting factor, at least for some types of cultivation, and means to sever them beforehand (or contextually) might be needed. Alternatively, harvesting might be done leaving the cultivation in place, and the cultivation system might be recovered only after the roots have decomposed and are a smaller obstacle to removal. In still another variation, the system might be completely biodegradable and not present anymore at time of the new plantation.

The use of such deployment techniques can result in the deployment of a complete cultivation system, possibly of diameter of several hundred meters of more, in a time which is much shorter than that required with traditional methods. Especially for deployment in open sea, the speed can be essential to be able to operate within narrow weather windows. The reduction in time and in the use of personnel moreover determines a drastic reduction in cost for the installation.

While this invention has been described as having exemplary designs, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

1. A modular agriculture system for use underwater, the system comprising:
a plurality of node elements (101) each including an agricultural unit:
a plurality of connection elements (201) for inter-connecting at least some of said nodes (101) to form a mesh-like structure with nodes (101) at the mesh junctions, said connection elements having a profile such that when in use and placed underwater they present a low resistance to the action of waves and currents;
a plurality of tensioning elements (310) for connection to the mesh-like structure to place the connection elements in tension; and
at least two anchor elements (301) for securing the mesh-like structure to the sea bottom.

2. A system according to claim 1 wherein the connection elements have a low cross-section.

3. A system according to any preceding claim 1 wherein the or each agricultural unit (101) may be one of either a planter for seaweed and/or other underwater plants, or a feeder for fish and/or other underwater animals.

4. A system according to any preceding claim wherein at least some of the connection elements (201) are flexible.

5. A system according to any preceding claim, wherein at least one of the node elements (101) includes a coupling arrangement for a connection element which allows a connection element to move therethrough and thereby move relative to the node element.

6. A system according to any preceding claim, wherein at least part of the connection elements (201) are biodegradable.

7. A system according to any preceding claim, wherein at least one of the node elements (101) includes a substrate to facilitate rooting of plants or seaweeds positioned on them.

8. A system according to any preceding claim, wherein the geometry of the inter-connected mesh-like structure comprising connection lines (201) and tensioning elements (301) is selected so that the tension applied via the tensioning element will distribute evenly through at least part of the mesh-like structure.

9. A system according to any of the preceding claim, wherein a or the anchor element (301) comprises a bottom fixture such as an anchor, or a surface penetrating component, a suction system, or a weight, or a combination of these.

10. A system according to any preceding claim, wherein a tensioning element comprises tension generating devices like coils, elastomers, pneumatic or hydraulic or electromechanical actuators or ropes or cables pulled by floaters or by weights, possibly with the use of pulleys or other means to deviate the direction of the tension thus generated.

11. A system according to any preceding claim, wherein a node element (101) contains means to distribute light or nutrients in its immediate vicinity.

12. A system according to any preceding claim, wherein a node element contains means to keep away or control predators or pests, like cages, sound emitters (possibly of very high or very low frequency), electromagnetic emitters (possibly of low frequency or of very high frequency, or of light) or substance emitters.

13. A system according to any preceding claim, wherein a node element contains fixtures like anchors or surface penetrating components or weights, or a combination of the above, to further reduce relative motion with respect to the ground.

14. A system according to any preceding claim, wherein a node element contains means to monitor the surrounding environment, means to mitigate the accumulation of sediments, to produce heat, to produce cold, to vary the percentage of some gases diluted in the surrounding water or any combination of the above.

15. A system according to any preceding claim, further including at least one service node element for inclusion in the mesh-like structure and containing means to provide useful services to the cultivation.

16. A system according to any preceding claim, wherein a node element or a service node element includes means for connection to power cables, to data cables or to pipes.

17. A system according to any preceding claim, further including a power hub, a data hub, a storage device or a combination of the above, for connection to a node element or service node element and/or to a connecting elements.

18. A system according to any preceding claim, further including one or more devices to convert into usable energy the mechanical energy from waves, the mechanical energy from currents, the light, the thermal energy from an underground reservoir, the salinity gradient, the thermal gradient or other sources of renewable energy.

19. A system according to any preceding claim, wherein the mesh-like structure of nodes and connecting elements is prepared in a way which allows for it to be deployed by an unmanned underwater vehicle.

20. A system according to any preceding claim, wherein the mesh of nodes and connecting elements is prepared in a way which allows for it to be assembled underwater by a mechanical system prior to deployment

21. A method of deploying the system of any of claims 1 to 20 comprising the steps of:
i) providing at least two stores of tensioning lines at separated locations;
ii) connecting the tensioning lines from each of those stores to a controllably moveable vessel;
iii) withdrawing said tensioning lines from their respective stores by moving the respective vessels away from the respective stores of tensioning lines; and
iv) attaching connection elements to and between said tensioning lines as they are withdrawn from the respective stores of tensioning lines.

22. A method according to claim 20 wherein the stores of tensioning lines are located on shore.

23. A method according to claim 21 or claim 22 wherein the stores of tensioning lines are each a roll of tensioning line.

24. A method according to any of claims 21 to 23 comprising the further steps of:
v) disengaging the tensioning lines from their respective stores once the mesh-like structure is complete; and
vi) towing a completed mesh-like structure away from the locations of the stores of tensioning line.

25. A method according to claim 24 wherein the ends of the tensioning lines disengaged from the stores are themselves connected to further controllably moveable vessels and the tensioning lines are kept in tension.

26. A method according to any of claims 21 to 25 wherein the controllably movable vessels may be remotely operated or manned, surface, aerial or underwater vessels or drones.
